(19) United States
(12) Patent Application Publication
(10) Pub. No.: US 2023/0046591 A1
(43) Pub. Date: Feb. 16, 2023

(54) DOCUMENT AUTHENTICITY VERIFICATION IN REAL-TIME

(71) Applicant: Capital One Services, LLC, McLean, VA (US)

(72) Inventors: Erik NEIGHBOUR, Arlington, VA (US); Timothy TRAN, Springfield, VA (US)

(73) Assignee: Capital One Services, LLC, McLean, VA (US)

(21) Appl. No.: 17/399,138

(22) Filed: Aug. 11, 2021

(51) Int. Cl. G06T 7/593; B42D 25/30; B42D 25/23

(52) U.S. Cl. CPC G06T 7/593; B42D 25/30; B42D 25/23; G06T 2207/30176; G06T 2207/10012

(57) ABSTRACT

A method for determining authenticity of a document in real-time is disclosed. The method being performed by a processor includes receiving image data of a document. The image data corresponds to at least two images of the document taken simultaneously using at least two cameras. The method includes analyzing the image data to determine a plurality of measurements corresponding to the document along three dimensions. The method includes a thickness at a plurality of location points on the document based on the plurality of measurements, and determining authenticity of the document in real-time based on the determined thickness of the document at the plurality of location points.

### TECHNICAL FIELD

Embodiments of the present disclosure are related to image and/or electronic document analysis, such as verifying the authenticity of a document being imaged or scanned for upload via user equipment prior to electronic transmission over a network.

### BACKGROUND

Computer-based or mobile-based technology allows a user to upload an image or other electronic version of a document for various purposes, for example, a foreign visa application. Whether the user is uploading an image of an authentic document or a forgery cannot always be determined. A fraudster may not be in possession of the actual physical document and may, for example, print a fake copy of a document on paper and attempt to scan that instead. If an authentication system cannot differentiate between an image of the authentic document and an image of the forgery, the authenticity of the document being uploaded cannot be verified.

### BRIEF DESCRIPTION OF THE DRAWINGS/FIGURES

The accompanying drawings are incorporated herein and form a part of the specification.

FIG. 1A illustrates an example of document authentication in real-time in accordance with some embodiments.

FIG. 1B and FIG. 1C illustrate another example of document authentication in real-time in accordance with some embodiments.

FIG. 2 illustrates a flow chart of steps for document classification, in accordance with some embodiments.

FIG. 3 illustrates example user equipment in accordance with some embodiments.

FIG. 4 illustrates an example computer system, in accordance with some embodiments.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for document authentication in real-time on the client-side before uploading the files to an application server.

A fraudster attempting to impersonate a real or imaginary person may need to provide photographic evidence of an identification document, such as a driver's license or passport. For example, an image of such an identification document may need to be submitted through a website or user application in order to access a financial account, apply for a foreign visa, apply for a loan, apply for an apartment rental, etc. The fraudster may create a counterfeit document, such as a printout or screen image. The fraudster may then attempt to use the counterfeit document by taking a picture of the counterfeit document with a user device, and uploading the resulting image to a server via a corresponding website or application located on the user device. Once the document image is uploaded to the application server, it would be difficult to determine whether the image received at the application server is of an authentic document. Embodiments of the present disclosure perform real-time authentication of a document that distinguishes between a legitimate three-dimensional document and a counterfeit two-dimensional document, such as those printed on a sheet of paper or displayed on a computer screen.

Many user devices are now equipped with multiple cameras configured to take different types of images (e.g., telephoto and wide angle). Typically, only one camera is used by the user device at a given time. According to embodiments of the present disclosure, user devices having multiple cameras can be leveraged to take at least two simultaneous images (via the multiple cameras) of a document being imaged or scanned by a user on the client-side. This occurs before the image is transmitted to an application server. In other words, before the image or scanned copy is electronically transmitted to the application server, a determination is made whether the user has scanned or imaged an actual, real identification document, or only a picture of the real document (or a forgery) as printed on a paper, a computer screen, etc.

Various embodiments in the present disclosure describe authenticating the document being imaged or scanned by a user in real time when the user takes an image of the document with a user equipment for submission through an application. The user equipment (“UE”) may be a user device having a processor and at least two cameras, such as, but not limited to, a mobile telephone, a tablet, a laptop computer, a PDA, or the like. The user may be required to use a specific application downloaded and installed on the user's user equipment, or a particular website. The application or website, when used to take an image of the document, may activate at least two cameras of the user equipment to take two separate images of the document simultaneously. The at least two cameras on the user equipment are physically separated. Accordingly, based on the known physical distance between the at least two cameras of the user equipment, the two images of the document taken simultaneously may be analyzed using known triangulation techniques to determine depth of the document.

Based on the type of the document being imaged, which may be determined automatically as described in the U.S. patent application Ser. No. 17/223,922, titled “Document Classification of Files in the Browser Before Upload,” filed on Apr. 6, 2021, which is hereby incorporated by reference in its entirety, the determined depth of the document being imaged may be compared against a preconfigured value of a depth of the document. For example, the depth of a standard driver's license may be known. If the determined depth of the document matches the preconfigured value for the depth of the document, then it may be affirmatively confirmed that the image is of an authentic document. The image data and the determined authentication status may then be sent to the application server. Accordingly, processing time and computational resources at the application server for determining whether the image received at the application server is of a real document or a forged document are saved.

To determine whether the identification document being imaged or scanned is a real document, the at least two cameras of the user equipment may form a stereoscopic camera. By way of a non-limiting example, one or more cameras of the user equipment may be a standard camera, a wide-angle camera, an ultra-wide angle camera, a telephoto camera, a true-depth camera, a light detection and ranging (LIDAR) camera, or an infrared camera. The stereoscopic and/or depth-detecting cameras, for example, may be used to measure distances to the surface of the document and to the background against which the document is set for imaging or scanning. Based on a difference between the measured distance to the surface of the document and the background against which the document is set, the depth or thickness of the document may be determined. As stated above, the determined depth or thickness of the document may then be used to determine the document's authenticity. In addition to the depth or thickness of the document, any raised lettering on a surface of the document may also be used to determine the document's authenticity.

Various embodiments of these features will now be discussed with respect to the corresponding figures.

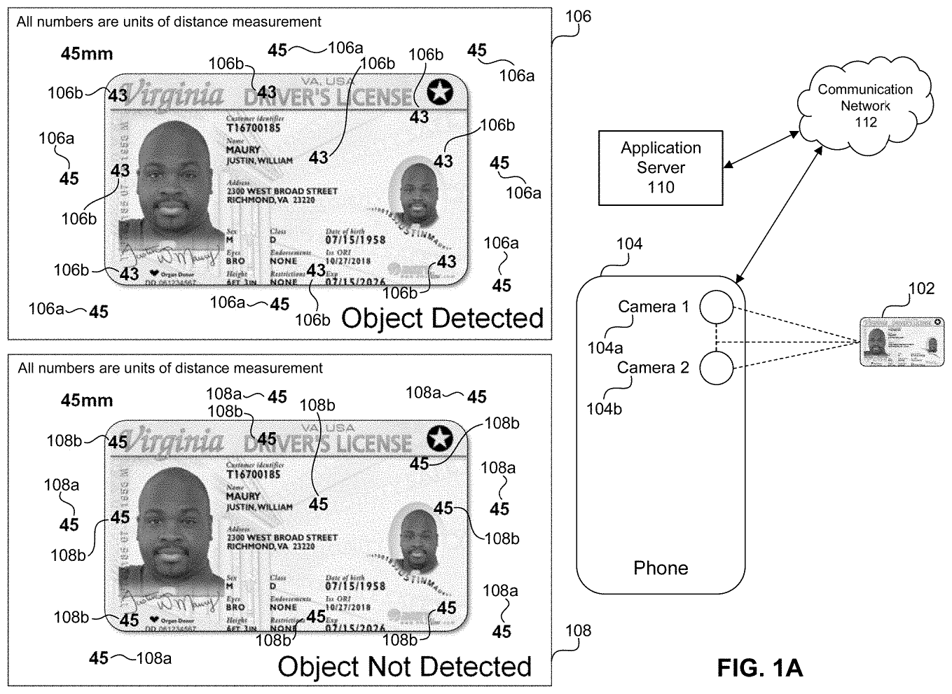

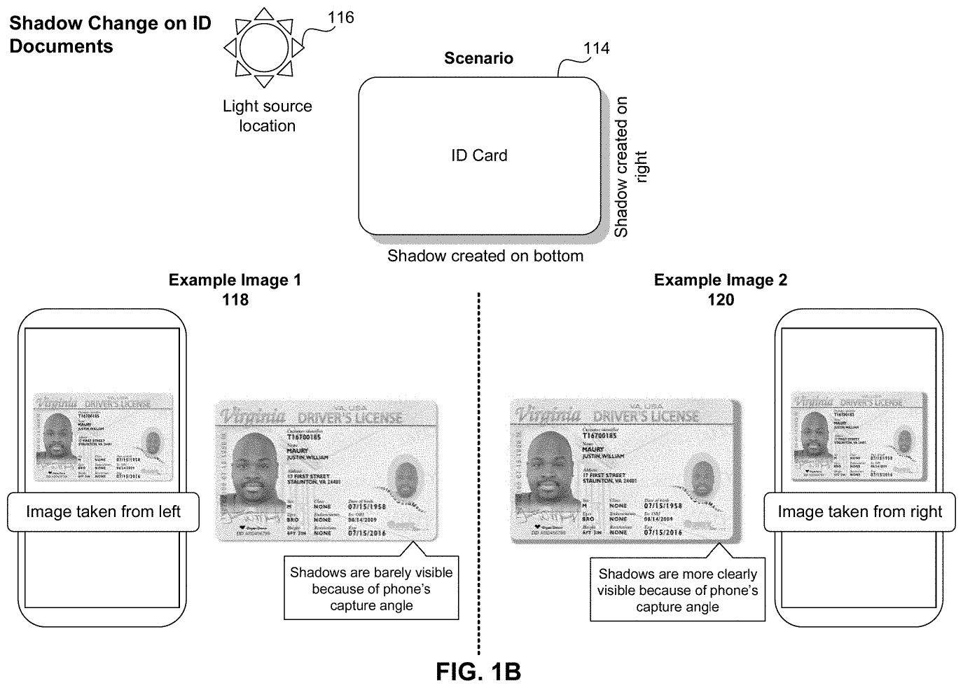

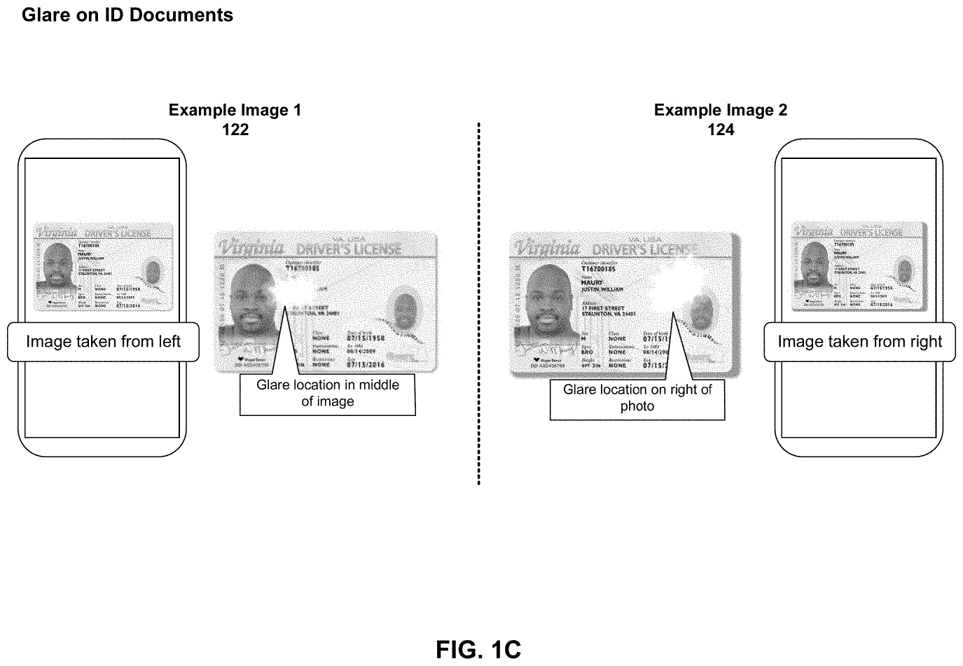

FIG. 1A illustrates an example of document authentication in real-time in accordance with some embodiments.

As shown in FIG. 1A, a user may take an image of a document 102. The document 102, for example, may be an actual physical driver's license. The user may be taking the image of the document 102, for example, to apply online for a passport application, an application for a loan, an application for lease of an apartment, or the like. A user equipment 104 may be configured to detect depth of the document 102. By way of a non-limiting example, the user equipment 104 may be equipped with at least two cameras, 104a and 104b, to determine the depth of the document 102. The two cameras 104a and 104b may collectively form a stereoscopic camera. In some embodiments, by way of a non-limiting, an infrared camera, a LIDAR, and/or a true-depth camera may be used instead of at least two standard cameras.

By way of a non-limiting example, the user equipment 104 may be a smart phone, a laptop, a desktop, a tablet, a smart watch, and/or an Internet-of-Thing (IoT) device, etc. The user may be required to use a specific application downloaded and installed on the user's user equipment 104, or a particular website (not shown). By way of a non-limiting example, the specific application may be a mobile application or a rich web browser application. The mobile application or the rich web browser application, or the particular website, when used to take an image of the document 102, may activate the at least two cameras 104a and 104b of the user equipment 104 to take two separate images of the document 102 simultaneously. The at least two cameras 104a and 104b of the user equipment 104 are physically separated. Accordingly, based on the known physical distance between the at least two cameras 104a and 104b of the user equipment 104, the two images of the document 102 taken simultaneously may be analyzed using known triangulation techniques to determine a depth of the document 102.

The determined depth of the document 102 being imaged may then be compared against a preconfigured value of a depth of the document 102 (e.g., based on an expected value for the type of document 102). If the determined depth of the document 102 matches the preconfigured value for the depth of the document, then it may be affirmatively confirmed that the document 102 is an authentic document. The image data and the determined authentication status may then be sent to an application server 110 over a communication network 112.

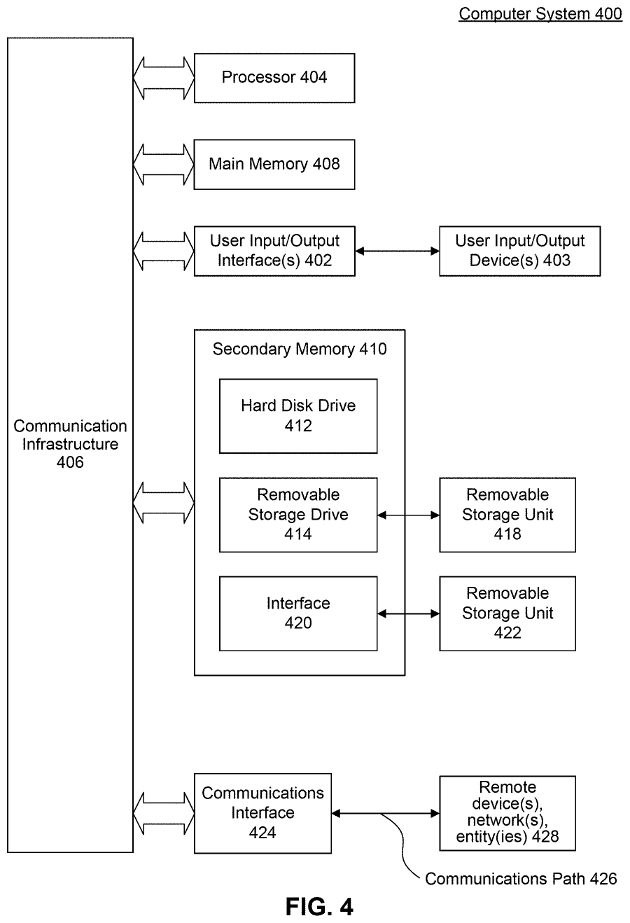

In some embodiments, the communication network 112 may be a wireline or wireless network. The wireless network, for example, may be a 3G, 4G, 5G, or 6G network, a local area network (LAN), and/or a wide area network (WAN), etc. The application server 110 may be a backend server as described in detail below with reference to FIG. 4.

In some embodiments, the user may be required to place the document 102 on a surface, for example, a desk, while taking images using the user equipment 104. As stated above, the user may be required to use a specific application installed on the user equipment 104, or visit a particular website using the user equipment 104, which would activate the two cameras 104a and 104b to simultaneously take an image of the document 102. Using known triangulation techniques, a depth or height corresponding to various location points of the document 102 may be determined.

FIG. 1 illustrates two example scenarios for document 102. In scenario 106, the document is a legitimate identification document; in scenario 108, the document is merely a copy printed on a sheet of paper or displayed on a screen. In scenario 106, using the two images taken simultaneously by cameras 104a and 104b, the depth or the height at various location points 106a and 106b—both on and off the apparent surface of the identification document—may be calculated. The distance from the user equipment 104 to location points 106a (i.e., points that are not on the apparent surface of the document) may be determined as being x units, for example, 45 units. For all the location points 106b that are on the apparent surface of the physical document, the distance may be recorded as being y units, for example, 43 units. Accordingly, based on the difference between the measured distance to the surface of the document, for example, 43 units, and the measured distance to the background against which the document is set, for example, 45 units, the depth or height of the document being imaged may be determined to be 2 units.

Accordingly, it can be confirmed that the document being imaged is not a photocopy of the actual physical document, but rather is the actual three-dimensional, physical document. Thus, the authenticity of the document being imaged or scanned may be determined in real-time.

While scenario 106 in FIG. 1 shows the depth at various locations on the document 102, which is an authentic driver's license, scenario 108 shows the depth at various locations on another document, which in this example is a paper copy of the document 102. For example, a fraudster may have obtained a copy of someone's legitimate driver's license, or generated a counterfeit driver's license using, e.g., a computer. The fraudster may then attempt to submit an image of the fake driver's license to an application server. However, when the two images taken simultaneously by the two cameras 104a and 104b are processed to determine the depth at various points on the paper copy of the document, as shown in scenario 108, all the points may be identified as being the same distance from the camera. For example, the distance from the user equipment 105 to location points 108a (i.e., points that are not on the apparent surface of the document) may be determined as being 45 units. For all the location points 108b that are on the apparent surface of the physical document, the distance may also be recorded as being 45 units. Accordingly, the difference between the measured distance to the apparent surface of the document and the measured distance to the background against which the document is set may be determined to be 0 units. Accordingly, it can be confirmed that the document being imaged is a photocopy of the actual physical document, and not an actual physical document. Thus, the authenticity of the document being imaged or scanned may be determined in real-time.

In some embodiments, the user may identify a type of document being imaged. In some embodiments, based on the image taken by the camera 104a and/or the camera 104b, the type of the document may be automatically determined as described in U.S. patent application Ser. No. 17/223,922, titled “Document Classification of Files in the Browser Before Upload,” filed on Apr. 6, 2021, which is hereby incorporated by reference in its entirety. Based on the type of the document being imaged, the calculated depth of the document may be compared with a preconfigured or expected value for the depth corresponding to the type of the document. For example, if the document being scanned is a driver's license, the preconfigured value for the depth of the document may be set to 2 units. Accordingly, if the document in scenario 106 is identified as a driver's license, and the determined depth of the document is also 2 units, then the document may be determined to be an authentic document. However, if the depth of the document, which is identified as a driver's license, is other than 2 units, then it may be determined that the document is not an authentic document.

In some embodiments, the depth of the document may be determined based on raised lettering on a surface of the document. For example, where the document is a credit card, a name of a credit card holder may be printed on the credit card using raised lettering. Accordingly, the depth of the document may be different at location points that are on the raised lettering. As stated above, the depth determined at various location points on the document may then be compared against the predetermined depth value corresponding to the various location points to determine the authenticity of the document.

In some embodiments, the document may include a transparent section. For example, many states' driver's licenses have a transparent section in a particular location on the driver's license. In some embodiments, a change in calculated depth at a particular location on the document may denote a transparent section of the document. The authenticity of the document may be determined based on the depth of the document in such a transparent section of the document. Accordingly, the depth at the transparent section of the driver's license and other non-transparent sections may be measured and compared with the expected depth(s) as described above to determine the authenticity of the document.

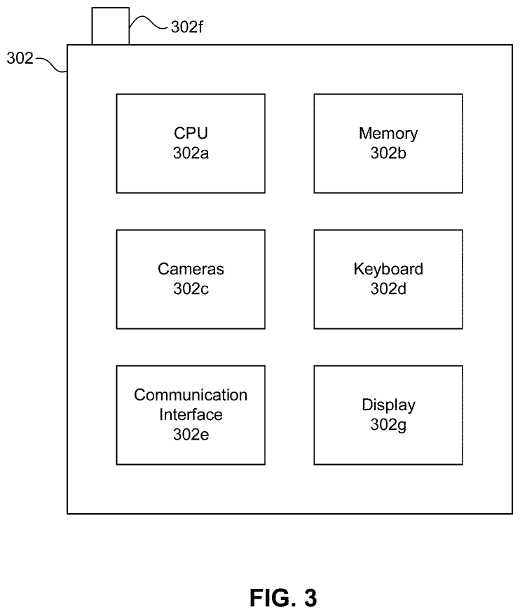

In some embodiments, the images taken simultaneously by cameras 104a and 104b of the UE 104 may be processed by a processor of the UE 104, as described below with reference to FIG. 3. The determined authentication status and the image data may then be communicated to the application server 110 over the communication network 112. Processing the images using the processor of the UE 104 allows the document to be authenticated in real-time, as the process is not hampered by transmission times back and forth to an application server. Further, processing the images at the UE 104 reduces the need for potentially sensitive or personal data, such as may appear on identification documents, to be sent over a network. Rather, the images containing the sensitive data are used only by the UE 104, and need not be transmitted anywhere by the UE 104.

In some embodiments, the authenticity of the document 102 may be determined by the application server 110. For example, when the processing power or available memory is insufficient at the user equipment 104, then the images taken simultaneously by the two cameras 104a and 104b may be transmitted to the application server 110. The authenticity of the document may then be determined by the application server 110 in the same manner as described above. The data sent from the user equipment 104 to the application server 110 may include the images and/or image data, and information about the user equipment 104. By way of a non-limiting example, the information about the user equipment 104 may include a model of the user equipment 104, and/or a specification of the cameras 104a and 104b including their physical orientation and/or placement on the user equipment 104. Accordingly, using the data received from the user equipment 104, a processor at the application server 110 may calculate a depth value corresponding to the various location points of the document to determine the authenticity of the document.

In some embodiments, when it is determined that the user has not scanned or imaged an actual document, the user may be notified by displaying a message on a display of the user equipment 104 to scan an original document. In other embodiments, when it is determined that the user has not scanned or imaged an actual document, the authentication status and the image data may still be communicated to the application server 110, but the user is not notified that a fraudulent document has been detected.

Thus, in accordance with some embodiments, based on the distance between the lenses of the two cameras 104a and 104b and differences between feature locations in the images taken simultaneously by cameras 104a and 104b, a geometric relationship, a three-dimensional value corresponding to various location points in the view area of the two cameras 104a and 104b, may be determined. By way of a non-limiting example, a multiangulation technique, such as a triangulation technique, may be used to determine a three-dimensional value of the various location points within the view area of the two cameras 104a and 104b. From the three-dimensional values of the various location points, a height or a depth at various location points in the view areas may be determined.

In some embodiments, instead of using two images taken simultaneously, a depth of various location points on the document may be measured by illuminating the document using modulated infrared or near-infrared A phase shill between the modulated infrared or near-infrared light and its reflection may be used to determine depth corresponding to the various location points on the document.

FIG. 1B and FIG. 1C illustrate another example of document authentication in real-time in accordance with some embodiments. In some embodiments, the user may be asked to scan the document 102 by slowly moving one or more cameras over the document, and changes in shadow and properties of the reflected light may be used to determine the authenticity of the document. As shown in FIG. 1B, when the real document 114 is being scanned or imaged, due to edges and surfaces of the three-dimensional document 114, there may be a difference in a shadow length from different angles. Shadows may be identified based on edge detection and image properties such as contrast and saturation, etc. As the user slowly moves one or more cameras over the document, multiple images may be taken by the one or more cameras. Since each image is taken at a different angle based on the camera's position over the document, the shadow length would be different in each image. As shown in FIG. 1B, a flashlight (not shown) on the user equipment 104 may act as a light source 116, while taking images of the document. As shown in FIG. 1B for an example image 1 118, when the real document 114 is being imaged with the camera on the left side, a shadow may not be visible due to a capture angle and a location of the flashlight on the user equipment 104. Similarly, as shown in an example image 2 120, when the real document 114 is being imaged with the camera on the right side, a shadow may be visible due to a different capture angle and flashlight location relative to the document.

In addition to the change in shadow length, a glare location would also be different in each image as shown in FIG. 1C. As shown in FIG. 1C for an example image 122, a glare may be seen in the middle of the image when the image is taken while the camera is on the left side of the real document. When the image is taken while the camera is on the right side of the real document, a glare may be seen on the right side of the image as shown in an example image 2 124. Accordingly, a change in the shadow length and/or glare location may be used to determine the document's authenticity. In contrast, if the document being scanned or imaged is only a copy of the actual physical document, then there would be no difference in the shadow length and/or glare location. Accordingly, based on the absence of shadow length change and/or glare location change, it may be determined that the document being scanned is a counterfeit document.

In some embodiments, camera 104a and/or camera 104b may be a true-depth camera, a light detection and ranging (LIDAR) sensor, etc., configured to create a three-dimensional (3D) map of the environment. For example, if camera 104a is a true-depth camera, an image taken by camera 104a can be analyzed using the user equipment's built-in audio-visual framework to identify a depth of various points within the image. For example, the AVFoundation tool native to many iPhones™ may be used to calculate a depth from the camera to an object of interest in the image, such as the document being authenticated.

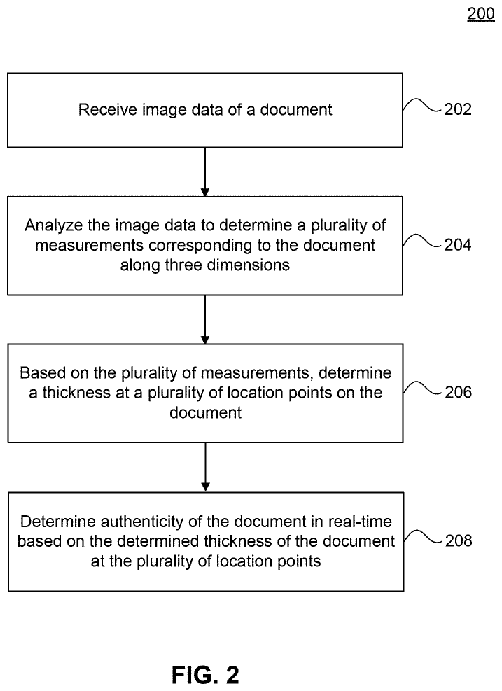

FIG. 2 illustrates a flow chart describing a method for document classification, in accordance with some embodiments. At 202, image data of a document may be received by a processor. For example, a user may image a document using a mobile application installed on the user's user equipment such as a smartphone, or by visiting a particular website. The user may be asked to place the document 102 on a surface such as a desk. When the user takes an image of the document 102, at least two cameras of the user equipment may be activated, each taking an image of the document simultaneously. The image data for the image taken by each of the at least two cameras then may be processed by the processor, which may be a processor 302a of the user equipment 302 or a processor 404 of an application server 400, as described below. The image data may include data corresponding to at least two images taken using cameras 104a and 104b. By way of a non-limiting example, the image data may include data corresponding to the modulated infrared or near-infrared light and the phase shift between the modulated infrared or near-infrared light and its reflection. The image data may include data corresponding to a 3D map created by a true-depth camera or a LIDAR sensor of the user equipment.

At 204, the received image data may be analyzed to determine a plurality of measurements corresponding to the document along three dimensions. In other words, three-dimensional values corresponding to various location points in the image field of view may be calculated. As described above, known triangulation or multiangulation techniques may be used to determine a three-dimensional value for each location point. In some embodiments, the image data may be based on a 3D map created by a true-depth camera or a LIDAR sensor, and the image data may include a three-dimensional value corresponding to various location points.

At 206, based on the three-dimensional values corresponding to the various location points, a depth or height corresponding to each of the various location points may be calculated, as described above with respect to FIG. 1.

At 208, the calculated depth corresponding to the various location points on the document may be used to determine the authenticity of the document, as described above with respect to FIG. 1. For example, in some embodiments, the depth or height corresponding to each location point may be compared against a preconfigured value of a depth for each given location point, or an overall thickness calculated for the document may be compared against a preconfigured thickness value for the document. For example, a driver's license may have a preconfigured thickness value of 2 mm. And when an image of the driver's license is taken with the driver's license placed on a desk, the difference between the depth corresponding to the various location points on the driver's license and other location points on the desk may be 2 mm. Since the difference between the calculated depths matches the preconfigured value for the driver's license, it may be determined that the user has taken an image of an actual driver's license. The image data may then be sent to an application server for further processing in regards to the user's application. The image data sent to the application server may include the document type and authentication status of the document.

FIG. 3 illustrates exemplary user equipment in accordance with some embodiments. As shown in FIG. 3, user equipment 302 may include a central processing unit (CPU) 302a, a memory 302b, cameras 302c, a keyboard 302d, a communication interface 202e, and a display 302g. The CPU 302a may be a processor, a microcontroller, a control device, an integrated circuit (IC), and/or a system-on-chip (SoC). The memory 302b may store instructions being performed by the CPU 302a. By way of a non-limiting example, the memory 302b may store application data for a mobile application downloaded on the user equipment 302. The cameras 302c may be cameras such as 104a and 104b.

In accordance with some embodiments, the user may use the keyboard 302d and the display 302g to launch the mobile application stored on the user equipment 302 to take an image or scan the document 102 using the cameras 302c. As described above, the mobile application may activate each camera 104a and 104b to take an image of the document 102 simultaneously. The data of the images taken simultaneously by the cameras 302c may be processed by the CPU 302a, as described above using FIG. 1 and/or FIG. 2 to determine the authenticity of the document 102. The image data and/or the determined authenticity of the document may be transmitted to the application server 110 by the UE 302 using the communication interface 302e and an antenna 302f.

In this way, embodiments of the present disclosure describe determining the authenticity of the document in real-time on the client-side before the document information is transmitted electronically to an application server.

FIG. 4 illustrates an example of a computer system, in accordance with some embodiments.

Various embodiments may be implemented, for example, using one or more well-known computer systems, such as a computer system 400 as shown in FIG. 4. One or more computer systems 400 may be used, for example, to implement any of the embodiments discussed herein, as well as combinations and sub-combinations thereof. By way of a non-limiting example, the computer system 400 may be used to implement the application server 110.

The computer system 400 may include one or more processors (also called central processing units, or CPUs), such as a processor 404. The processor 404 may be connected to a communication infrastructure or bus 406.

The computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 400 may also include a main or primary memory 408, such as random access memory (RAM). Main memory 408 may include one or more levels of cache. Main memory 408 may have stored therein control logic (i.e., computer software) and/or data.

The computer system 400 may also include one or more secondary storage devices or memory 410. The secondary memory 410 may include, for example, a hard disk drive 412 and/or a removable storage device or drive 414. The removable storage drive 414 may be a floppy disk drive, a magnetic tape drive, a compact disk drive, an optical storage device, tape backup device, and/or any other storage device/drive.

The removable storage drive 414 may interact with a removable storage unit 418. The removable storage unit 418 may include a computer-usable or readable storage device having stored thereon computer software (control logic) and/or data. The removable storage unit 418 may be a floppy disk, magnetic tape, compact disk, DVD, optical storage disk, and/any other computer data storage device. The removable storage drive 414 may read from and/or write to a removable storage unit 418.

The secondary memory 410 may include other means, devices, components, instrumentalities, or other approaches for allowing computer programs and/or other instructions and/or data to be accessed by the computer system 400. Such means, devices, components, instrumentalities, or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick, and USB port, a memory card and associated memory card slot, and/or any other removable storage unit and associated interface.

The computer system 400 may further include a communication or network interface 424. The communication interface 424 may allow the computer system 400 to communicate and interact with any combination of external devices, external networks, external entities, etc. (individually and collectively referenced by reference number 428). For example, the communication interface 424 may allow the computer system 400 to communicate with the external or remote devices 428 over communications path 426, which may be wired and/or wireless (or a combination thereof), and which may include any combination of LANs, WANs, the Internet, etc. Control logic and/or data may be transmitted to and from the computer system 400 via the communication path 426.

The computer system 400 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

The computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer-usable or readable medium having control logic (software) stored thereon may also be referred to herein as a computer program product or program storage device. This includes, but is not limited to, the computer system 400, the main memory 408, the secondary memory 410, and the removable storage units 418 and 422, as well as tangible articles of manufacture embodying any combination of the foregoing. Such control logic, when executed by one or more data processing devices (such as the computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

What is claimed is:

1. A method, comprising:
receiving, at a processor, image data of a document, wherein the image data corresponds to at least two images of the document taken simultaneously using at least two cameras;
analyzing, by the processor, the image data to determine a plurality of measurements corresponding to the document along three dimensions;
based on the plurality of measurements, determining, by the processor, a thickness at a plurality of location points on the document; and
determining, by the processor, authenticity of the document in real-time based on the determined thickness of the document at the plurality of location points.

2. The method of claim 1, wherein the analyzing the image data comprises determining a three-dimensional value corresponding to the plurality of location points of the document.

3. The method of claim 2, wherein the analyzing the image data further comprises using a multiangulation technique to determine the three-dimensional value corresponding to the plurality of location points of the document.

4. The method of claim 3, wherein the multiangulation technique is a triangulation method of measuring the three-dimensional value corresponding to the plurality of location points.

5. The method of claim 1, wherein the determining the authenticity comprises verifying a value of depth corresponding to each location point of the plurality of location points according to one or more preconfigured values.

6. The method of claim 1, wherein the determining the authenticity further comprises verifying a height or a depth of one or more letters or images on the document.

7. The method of claim 1, wherein the document is a driver's license.

8. The method of claim 1, wherein the processor is a processor of a user device.

9. The method of claim 1, wherein the processor is a processor of an application server.

10. A user device for determining authenticity of a document, the user device comprising:
one or more processors; and
a memory communicatively coupled to the one or more processors, the memory having instructions stored thereon that, when executed by the one or more processors, cause the one or more processors to:
receive image data of the document, wherein the image data corresponds to at least two images of the document taken simultaneously using at least two cameras;
analyze the image data to determine a plurality of measurements corresponding to the document along three dimensions;
based on the plurality of measurements, determine a thickness at a plurality of location points on the document; and
determine the authenticity of the document in real-time based on the determined thickness of the document at the plurality of location points.

11. The user device of claim 10, wherein, to analyze the image data, the instructions further cause the one or more processors to determine a three-dimensional value corresponding to a plurality of location points of the document.

12. The user device of claim 11, wherein, to analyze the image data, the instructions further cause the one or more processors to use a multiangulation technique to determine the three-dimensional value corresponding to the plurality of location points of the document.

13. The user device of claim 12, wherein the multiangulation technique is a triangulation method of measuring the three-dimensional value corresponding to the plurality of location points.

14. The user device of claim 10, wherein, to determine the authenticity, the instructions further cause the one or more processors to verify a value of depth corresponding to each location point of the plurality of location points according to one or more preconfigured values.

15. The user device of claim 10, wherein, to determine the authenticity, the instructions further cause the one or more processors to verify a height or a depth of one or more letters or images on the document.

16. The user device of claim 10, wherein the document is a driver's license.

17. A non-transitory, tangible computer-readable device having instructions stored thereon that, when executed by at least one computing device, causes the at least one computing device to perform operations comprising:
receiving image data of a document, wherein the image data corresponds to at least two images of the document taken simultaneously using at least two cameras;
analyzing the image data to determine a plurality of measurements corresponding to the document along three dimensions;
based on the plurality of measurements, determining, by the processor, a thickness at a plurality of location points on the document; and
determining, by the processor, authenticity of the document in real-time based on the determined thickness of the document at the plurality of location points.

18. The non-transitory, tangible computer-readable device of claim 17, wherein the operations for determining the authenticity comprise verifying a height or a depth of one or more letters or images on the document.

19. The non-transitory, tangible computer-readable device of claim 17, wherein the operations for analyzing the image data comprise using a multiangulation technique to determine a three-dimensional value corresponding to the plurality of location points of the document.

20. The non-transitory, tangible computer-readable device of claim 17, wherein the operations for determining the authenticity comprise verifying a value of depth corresponding to each location point of the plurality of location points according to one or more preconfigured values.
